(19) United States
(12) Patent Application Publication
(10) Pub. No.: US 2009/0096773 A1
(43) Pub. Date: Apr. 16, 2009

(54) ELECTROPHORETIC DISPLAY DEVICE, ELECTRONIC APPARATUS, AND METHOD OF DRIVING ELECTROPHORETIC DISPLAY DEVICE

(75) Inventors: Soichi MORIYA, Suwa (JP); Tsutomu MIYAMOTO, Shiojiri (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/247,480

(22) Filed: Oct. 8, 2008

(30) Foreign Application Priority Data
Oct. 15, 2007 (JP) 2007-268266

(51) Int. Cl. G09G 3/30; G06F 3/038

(52) U.S. Cl. 345/205; 345/76

(57) ABSTRACT

An electrophoretic display device includes a common electrode and a plurality of pixel electrodes, a disperse system containing electrophoretic particles, the disperse system being held between the common electrode and the plurality of pixel electrodes. The electrophoretic display device includes a switching transistor and a control portion. the switching transistor supplies a corresponding one of the pixel electrodes with a low electric potential signal or a high electric potential signal supplied from a signal line. The control portion controls an electric potential applied between each of the pixel electrodes and the common electrode to cause the electrophoretic particles to move. The control portion provides, in a period during which control for causing the electrophoretic particles to move is performed, a first period during which the switching transistor is held in an on state and a second period during which the switching transistor is held in an off state. The first period continues until charging of the pixel electrode is complete. The second period continues from an end of the first period until movement of the electrophoretic particles is complete.

### BACKGROUND

1. Technical Field

The present invention relates to an electrophoretic display device, an electronic apparatus, and a method of driving an electrophoretic display device.

2. Related Art

An electrophoretic display device is formed so that electrophoretic fluid dispersion that includes one or more types of electrophoretic particles and an electrphoretic dispersion medium is sealed between a pair of opposite electrode plates, at least one of which is transparent. Applying a voltage between the two electrodes causes electrophoretic particles to move in the electrophoretic dispersion medium, and a change in dispersion of the electrophoretic particles varies optical reflection property to thereby make it possible to display information. At this time, if one of the electrodes is formed of a plurality of divided pixel electrodes, by controlling an electric potential of each pixel electrode, a difference in dispersion of particles in each pixel is produced to thereby make it possible to form an image.

Each pixel electrode is connected to a TFT (Thin Film Transistor), which is a switching element. By applying a predetermined voltage to the gate electrode of the TFT, the TFT enters an on state to cause a drain current to flow, so that the connected pixel electrode is supplied with an image signal. Note that it has been suggested that the TFT may employ a flexible, light organic transistor that allows cost reduction.

JP-A-2002-149115 describes an active matrix electrophoretic display device that uses electronic ink. The electrophoretic display device described in JP-A-2002-149115 employs a driving method in which, when a display content is changed, all the pixel electrodes are set to the same electric potential and a voltage is applied between the common electrode and the pixel electrodes to thereby erase the content displayed at that time over the entire display area, and, after that, another display content is displayed.

When a TFT is made to enter an on state, for example, a P-type transistor is applied with a negative voltage and an N-type transistor is applied with a positive voltage; however, in terms of transistor structure, it has been known that, if the gate electrode of a P-type transistor is applied with a negative bias voltage or the gate electrode of an N-type transistor is applied with a positive bias voltage, carriers are trapped on a semiconductor surface. Trapping of carriers leads to fluctuation in threshold voltage at a boundary between an on state and an off state of a transistor or fluctuation in drain current in an on state of the transistor. This results in a decrease in contrast of the electrophoretic display device or may produce a problem such as nonoperation of the electrophoretic display device in some cases. Particularly, the organic transistor noticeably has a problem of characteristic degradation due to the carrier trap. The above problem regarding fluctuation in threshold in an organic transistor is also described in “Bias-induced threshold voltages shifts in thin-film organic transistors” H. L. Gomes, P. Stalling a, et. al., APPLIED PHYSICS LETTERS, Vol. 84, No. 16, 19 APR. 2004, p 3184-p 3186 and “Light-induced bias stress reversal in polyfluorene thin-film transistors” A. Salleo, R. A. Street, JOURNAL OF APPLIED PHYSICS, Vol. 94, No. 1, 1 JUL. 2003, p 471-p 479.

### SUMMARY

An advantage of some aspects of the invention is that it suppresses degradation of characteristic of a transistor used as a switching element, and maintains the display quality of the electrophoretic display device.

An aspect of the invention provides an electrophoretic display device that includes an electrophoretic element, having disperse system containing electrophoretic particles, that is held between a common electrode and a plurality of pixel electrodes, and a display portion formed of a plurality of pixels. The electrophoretic display device includes switching transistors and a control portion. Each of the switching transistors supplies a corresponding one of the pixel electrodes with a low electric potential signal or a high electric potential signal supplied from a signal line. The control portion controls an electric potential applied between each of the pixel electrodes and the common electrode to cause the electrophoretic particles to move to thereby form an image. The control portion provides, in a period during which control for causing the electrophoretic particles to move is performed, a first period during which the switching transistors are held in an on state and a second period during which the switching transistors are held in an off state. The first period continues until charging of the pixel electrodes is complete. The second period continues from an end of the first period until movement of the electrophoretic particles is complete.

As described above, a period during which electrophoretic particles are caused to move includes a first period during which the switching transistors are held in an on state to supply signals to the pixel electrodes for charging the pixel electrodes and a second period during which the switching transistors are held in an off state to allow electrophoretic particles to move by differences in electric potential that are set through charging during the first period, so that a period during which a positive or negative bias voltage, which causes degradation of characteristic of the switching transistors, is applied only during the first period. This suppresses degradation of characteristic of the transistors due to carrier trap and, hence, the display quality of the electrophoretic display device may be maintained.

In the above electrophoretic display device, each switching transistor may enter an on state when a gate electrode of the switching transistor is supplied with a first electric potential and may enter an off state when the gate electrode is supplied with a second electric potential, wherein, during the second period, the control portion may supply the low electric potential signal from the signal line to each switching transistor when the first electric potential is smaller than the second electric potential, and the control portion may supply the high electric potential signal from the signal line to each switching transistor when the first electric potential is larger than the second electric potential.

According to the aspect of the invention, when the characteristic of each switching transistor degrades owing to a negative bias voltage, that is, when the first electric potential is smaller than the second electric potential, the low electric potential signal is supplied from the signal line to each switching transistor during the second period, so that a positive bias voltage is applied between the gate and source of each switching transistor. Hence, it is possible to recover degradation of characteristic due to a negative bias voltage applied during the first period. In addition, when the characteristic of each switching transistor degrades owing to a positive bias voltage as well, a negative bias voltage is applied between the gate and source of each switching transistor during the second period, so that it is possible to recover degradation of characteristic that arises during the first period.

In the above electrophoretic display device, the control portion may provide a reset period during which differences in electric potential between the common electrode and the pixel electrodes in all the pixels are set to be equal during times when an image displayed on the display portion is rewritten from a first image to a second image to thereby make the entire display portion appear to be the same gray-scale level, wherein the reset period may include the first period and the second period.

Depending on the status of an image before resetting, a short reset period may leave a residual image that portion of the previous image remains on the display portion. In this case, the reset period needs to be set relatively long. According to the aspect of the invention, because, during the reset period, a period during which a positive or negative bias voltage, which causes degradation of characteristic of the switching transistors, is applied is only during the first period, it is particularly advantageous when the reset period is relatively long.

In the above electrophoretic display device, each switching transistor may be, for example, an organic thin film transistor. The organic thin film transistor noticeably has a problem of characteristic degradation due to carrier trap, so that it is possible to further effectively maintain the display quality of the electrophoretic display device.

In the above electrophoretic display device, when each switching transistor is a P-channel transistor, the control portion may supply the low electric potential signal from the signal line to each switching transistor during the second period. On the other hand, in the above electrophoretic display device, when each switching transistor is an N-channel transistor, the control portion may supply the high electric potential signal from the signal line to each switching transistor during the second period.

Another aspect of the invention provides any electronic apparatuses that include the above described electrophoretic display device as a display portion. The electronic apparatuses include a display device, a television device, an electronic book, an electronic paper, a watch, a clock, an electronic calculator, a cellular phone, and a personal digital assistant. In addition, the electronic apparatuses, for example, include a product that is apart from the concept of “apparatus”, such as a flexible paper-like or film-like object, a product that belongs to a real estate, such as a wall surface to which the above object is affixed, and a product that belongs to a movable body, such as a vehicle, an aircraft, and a ship.

Another aspect of the invention provides a method of driving an electrophoretic display device that includes an electrophoretic element, having disperse system containing electrophoretic particles, that is held between a common electrode and a plurality of pixel electrodes, a display portion formed of a plurality of pixels, and switching transistors, each of which supplies a corresponding one of the pixel electrodes with a low electric potential signal or a high electric potential signal supplied from a signal line, wherein an electric potential applied between each of the pixel electrodes and the common electrode is controlled to cause the electrophoretic particles to move to thereby form an image. The method includes, when the electrophoretic particles are caused to move, holding each switching transistor in an on state and holding each switching transistor in an off state. Holding each switching transistor in an on state continues until charging of the pixel electrode is complete. Holding each switching transistor in an off state continues from an end of holding each switching transistor in an on state until movement of the electrophoretic particles is complete.

As described above, causing electrophoretic particles to move includes holding each switching transistor in an on state to supply a signal to each pixel electrode for charging each pixel electrode and holding each switching transistor in an off state to allow electrophoretic particles to move by differences in electric potential that are set through the above charging, so that a positive or negative bias voltage, which causes degradation of characteristic of the switching transistors, is applied only when holding each switching transistor in an on state. This suppresses degradation of characteristic of the transistors due to carrier trap and, hence, the display quality of the electrophoretic display device may be maintained.

In the above method, each switching transistor may enter an on state when a gate electrode of the switching transistor is supplied with a first electric potential and may enter an off state when the gate electrode is supplied with a second electric potential, wherein, during times when holding each switching transistor in an off state, the low electric potential signal may be supplied from the signal line to each switching transistor when the first electric potential is smaller than the second electric potential, and the high electric potential signal may be supplied from the signal line to each switching transistor when the first electric potential is larger than the second electric potential.

According to the aspect of the invention, when the characteristic of each switching transistor degrades owing to a negative bias voltage, that is, when the first electric potential is smaller than the second electric potential, the low electric potential signal is supplied from the signal line to each switching transistor during times when holding each switching transistor in an off state, so that a positive bias voltage is applied between the gate and source of each switching transistor. Hence, it is possible to recover degradation of characteristic due to a negative bias voltage applied during times when holding each switching transistor in an on state. In addition, when the characteristic of each switching transistor degrades owing to a positive bias voltage as well, a negative bias voltage is applied between the gate and source of each switching transistor during times when holding each switching transistor in an off state, so that it is possible to recover degradation of characteristic that arises during times when holding each switching transistor in an on state.

### BRIEF DESCRIPTION OF THE DRAWINGS

The invention will be described with reference to the accompanying drawings, wherein like numbers reference like elements.

FIG. 1 is a view that shows a general electrical configuration of an electrophoretic display device according to a first embodiment of the invention.

FIG. 2 is a view that shows a structure of each pixel of the electrophoretic display device.

FIG. 3A to FIG. 3C are views that illustrate changes in a display portion of the electrophoretic display device when a display image is changed according to the first embodiment.

FIG. 4 is a timing chart that shows voltages of a common electrode, pixel electrode, data signal, and gate electrode of the electrophoretic display device according to the first embodiment.

FIG. 5A to FIG. 5C are views that schematically show operations of the electrophoretic display device when a display image is changed according to the first embodiment.

FIG. 6A to FIG. 6C are views that illustrate changes in the display portion of the electrophoretic display device when a display image is changed according to an alternative example of the first embodiment.

FIG. 7 is a timing chart that shows voltages of a common electrode, pixel electrode, data signal, and gate electrode of the electrophoretic display device according to the alternative example of the first embodiment.

FIG. 8A to FIG. 8C are views that schematically show operations of the electrophoretic display device when a display image is changed according to the alternative example of the first embodiment.

FIG. 9 is a timing chart that shows voltages of a common electrode, pixel electrode, data signal, and gate electrode of the electrophoretic display device according to a second embodiment.

FIG. 10 is a timing chart that shows voltages of a common electrode, pixel electrode, data signal, and gate electrode of the electrophoretic display device according to an alternative example of the second embodiment.

FIG. 11A to FIG. 11C are views that show examples of electronic apparatuses according to the aspects of invention.

### DESCRIPTION OF EXEMPLARY EMBODIMENTS

Embodiments of the invention will be described with reference to the accompanying drawings.

### First Embodiment

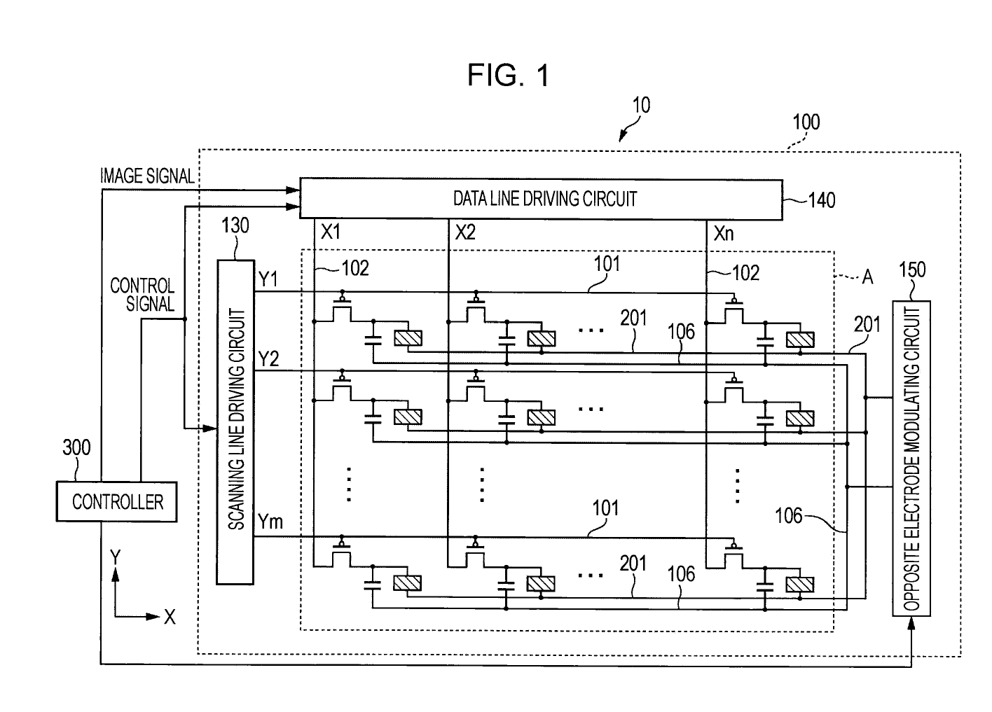

FIG. 1 is a view that shows a general electrical configuration of an electrophoretic display device 10 according to a first embodiment. An electrophoretic display panel A (display portion) is formed of a plurality of pixels. Each of the pixels includes a TFT 103, which serves as a switching element described later, and a pixel electrode 104 connected to the TFT 103. On the other hand, a scanning line driving circuit 130 and a data line driving circuit 140 are formed in a peripheral area of a device substrate 100. In addition, a plurality of scanning lines 101 are formed on the electrophoretic display panel A of the device substrate 100 so as to be parallel to an X direction shown in the drawing. In addition, a plurality of data lines 102 are formed so as to be parallel to a Y direction that is perpendicular to the X direction. Then, pixels are arranged in a matrix at positions corresponding to intersections of the scanning lines 101 and the data lines 102.

A controller (control portion) 300 is provided in a peripheral circuit of the electrophoretic display device 10. The controller 300 includes an image signal processing circuit and a timing generator. Here, the image signal processing circuit generates image data and an opposite electrode control signal and input the image data and the opposite electrode control signal respectively into the data line driving circuit 140 and the opposite electrode modulating circuit 150. The opposite electrode modulating circuit 150 supplies a common electrode of the pixels and an opposite electrode of holding capacitors with a bias signal Vcom and a power supply voltage Vs, respectively. For example, resetting of an image is set with the bias signal Vcom (reset signal) of a predetermined positive or negative level. The reset signal is output in a predetermined period before the data line driving circuit 140 outputs image data. The resetting is used to attract electrophoretic particles, which migrate in a dispersion medium, to the pixel electrodes or the common electrode and initialize the spatial state. In addition, the timing generator, at the time of reset setting or when image data are output from the image signal processing circuit, generates various timing signals for controlling the scanning line driving circuit 130 or the data line driving circuit 140.

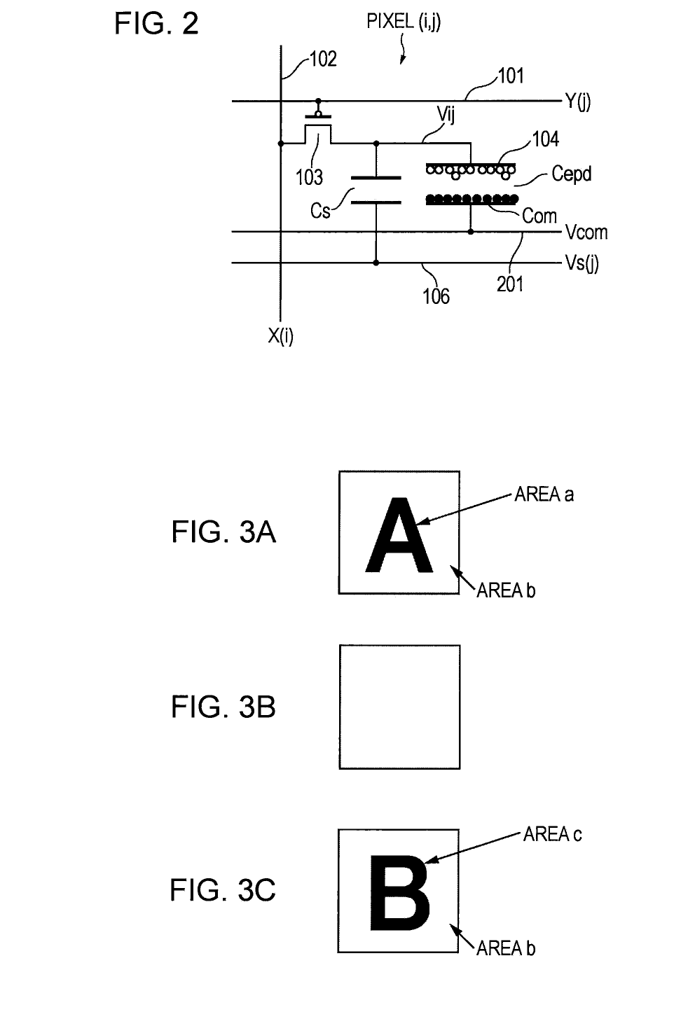

FIG. 2 is a view that shows a structure of each pixel of the electrophoretic display device 10. A pixel (i,j) located at the i-th row and the j-th column is formed to include a TFT 103, a pixel electrode 104 and a holding capacitor Cs. Here, the TFT 103 is a P-type organic transistor. The gate terminal of the TFT 103 is connected to a corresponding one of the scanning lines 101, and the source terminal of the TFT 103 is connected to a corresponding one of the data lines 102. Furthermore, the drain terminal of the TFT 103 is connected to the pixel electrode 104 and the holding capacitor Cs. The holding capacitor Cs holds a voltage applied to the pixel electrode 104 using the TFT 103. Each pixel is formed so that an electrophoretic layer is held between the pixel electrode 104 and the common electrode Com, and has a pixel capacitor Cepd that is based on an electrode surface area, a distance between the electrodes, and a dielectric constant of the electrophoretic layer. The common electrode Com is connected through a wiring 201 to the opposite electrode modulating circuit 150. In addition, the other terminal of the holding capacitor Cs is connected to a holding capacitor line 106. The holding capacitor line 106 is connected to a power supply Vs at the opposite electrode modulating circuit 150.

Electrophoretic particles are particles (polymer or colloid) that electrically migrate in an electrophoretic dispersion medium owing to a difference in electric potential and move toward a desired electrode side. The electrophoretic particles, for example, include black pigment, such as aniline black and carbon black, white pigment, such as titanium dioxide, zinc white, antimony trioxide, and aluminum oxide, yellow pigment, such as azo-based pigment such as monoazo, disazo and polyazo, iso-indolynone, chrome yellow, yellow iron oxide, cadmium yellow, and antimony, red pigment, such as quinacridone red and chrome vermilion, blue pigment, such as phthalocyanine blue, indanthrene blue, anthraquinone-based dye, iron blue, ultramarine blue, and cobalt blue, and green pigment, such as phthalocyanine green.

In regard to driving of the thus configured electrophoretic display device 10, a reset operation will be described. At a reset timing, the scanning line driving circuit 130 outputs selection signals to all the scanning lines 101. Here, because the switching transistors are of P type, the selection signals are low electric potential signals. As all the scanning line signals become active, the TFTs 103 connected to all the pixels that are connected to these scanning lines 101 enter an on state. At this time, the data line driving circuit 140 outputs a high electric potential or a low electric potential to all the data lines. The signals are supplied to all the pixel electrodes. In addition, the opposite electrode modulating circuit 150 supplies a low electric potential signal to the common electrode Com when a high electric potential is supplied to all the data lines and supplies a high electric potential signal to the common electrode Com when a low electric potential is supplied to all the data lines. At this time, because the same difference in electric potential is applied between the pixel electrode of each pixel and the common electrode, the entire display portion appears to be the same gray-scale level.

Next, an image writing operation will be described. During image writing operation, the scanning line driving circuit 130 sequentially supplies a selection signal to the scanning lines 101. As the j-th scanning line 101 is supplied with a selection signal to enter a selected state, the TFT 103 connected to this scanning line 101 enters an on state. At this time, in synchronization with the selection of the scanning line, a data signal Xi (image signal) supplied from the data line driving circuit 140 is written to the pixel electrode 104. At this time, the holding capacitor Cs is charged at a voltage level of the data signal Xi to hold electric charge in the pixel (pixel electrode and common electrode) after interruption of the TFT 103, thus maintaining the image formed by the electrophoretic particles. Each pixel performs display corresponding to a voltage level of a data signal to thereby display an image.

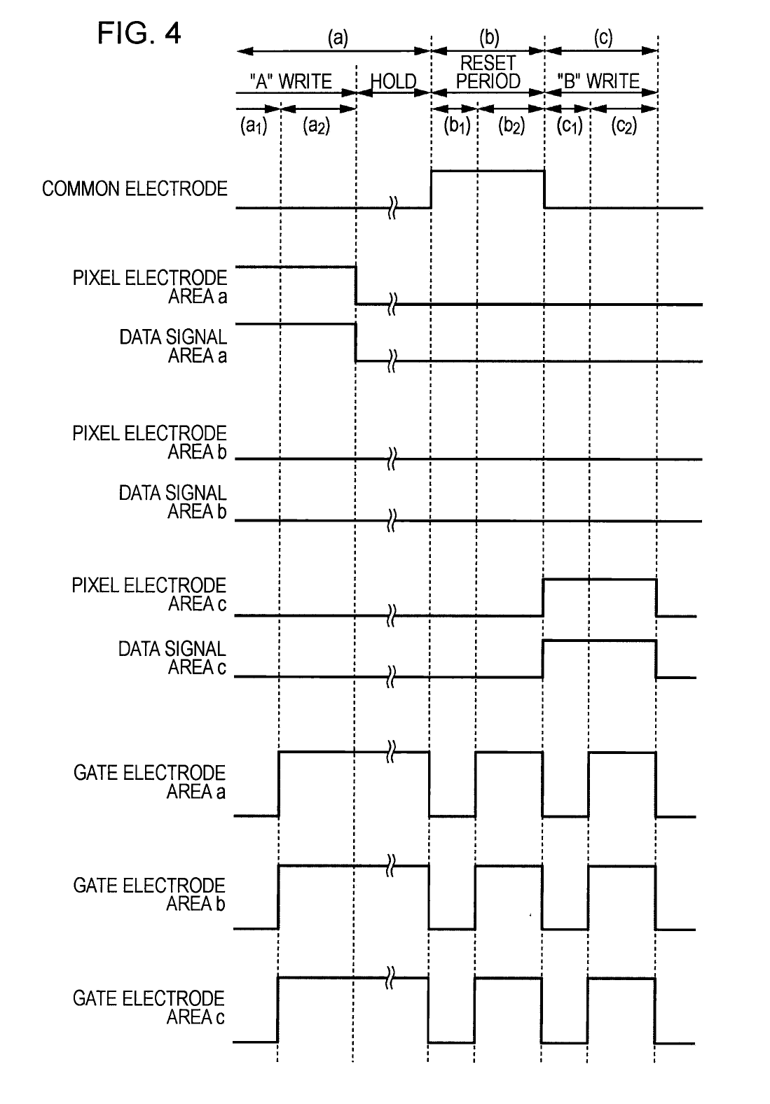

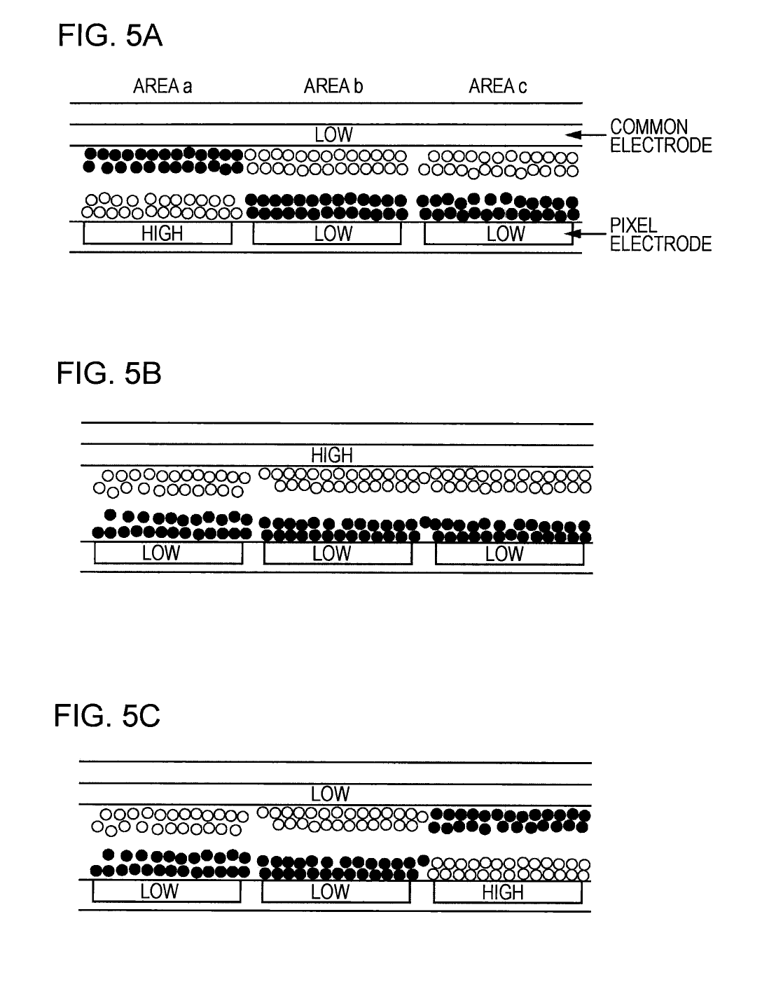

Next, a detailed operation of the electrophoretic display device 10 when a display image is changed will be described with reference to FIG. 3A to FIG. 5C. FIG. 3A to FIG. 3C are views that show a state of the display portion of the electrophoretic display device 10. FIG. 4 is a view that shows voltages of the common electrode Com, the pixel electrode 104, the data signal, and the gate electrode. FIG. 5A to FIG. 5C are views that schematically show operations of the electrophoretic display device when a display image is changed. Here, the electrophoretic particles include white electrophoretic particles that are negatively charged and black electrophoretic particles that are positively charged.

FIG. 3A shows a state in which the black character “A” is displayed on the white background on the display portion of the electrophoretic display device 10. Here, the area of the character “A” is denoted as area a, and the area of the background other than the area of the character “A” is denoted as area b. The entire display portion appears to be white display immediately before “A” is displayed. At the time of writing “A”, as shown in the period (a) in FIG. 4, the common electrode Com is applied with a low electric potential voltage. In addition, only the pixel electrodes 104 corresponding to the area a are applied with a high electric potential voltage, and the pixel electrodes 104 corresponding to the background area b are applied with a low electric potential voltage. By so doing, as shown in FIG. 5A, black electrophoretic particles that are positively charged move toward the common electrode Com only in the area a, and white electrophoretic particles that are negatively charged move toward the pixel electrodes 104. Thus, the character “A” is displayed.

Here, as shown in FIG. 4, a period (a) includes a period (a1) (first period) during which a low electric potential voltage is applied to the gate electrodes of each area and the TFTs 103 are held in an on state and a period (a2) (second period) during which a high electric potential voltage is applied to the gate electrodes of each area and the TFTs 103 are held in an off state. During the period (a1), the TFTs 103 are in an on state, so that the pixel electrodes 104 are supplied with a data signal. The period (a1) continues until charging of the pixel electrodes 104 and the holding capacitors Cs is complete.

During the period (a2), the TFTs 103 are in an off state, so that no data signals are supplied to the pixel electrodes 104; however, differences in electric potential between the pixel electrodes 104 and the common electrode Com, which are charged during the period (a1), are held to allow electrophoretic particles to move. Thus, the electrophoretic particles move over the periods (a1) and (a2).

In general, migration time of the electrophoretic particles (time that is taken for image rewriting) is longer than time that is taken for charging the pixel electrodes 104 and the holding capacitors Cs. For this reason, if the TFTs 103 are held in an on state during times when electrophoretic particles are moving, the gate electrodes of the TFTs 103 are applied with a negative bias voltage for a considerably long period of time to thereby accelerate degradation of characteristic of the TFTs 103. However, when the pixel electrodes 104 are once charged, the electrophoretic particles are caused to move even when the TFTs 103 are made to enter an off state. Thus, as in the case of the present embodiment, the period (a1) and the period (a2) may be provided.

After writing the character “A”, the pixel electrodes 104 attain the same electric potential as that of the common electrode Com in accordance with the time constant of an impedance between the common electrode Com and the pixel electrodes 104, thus holding the display image.

Next, FIG. 3B shows a state during a reset period, and an image is erased by making the entire display portion perform white display before a display image is changed. As shown in a period (b) in FIG. 4, during the reset period, the common electrode Com is applied with a high electric potential voltage, and all the pixel electrodes 104 are applied with a low electric potential voltage. By so doing, as shown in FIG. 5B, black electrophoretic particles move toward the pixel electrodes 104 in the area a, so that the entire display portion appears to be white.

During the reset period as well, as shown in FIG. 4, the period (b) includes a period (b1) (first period) during which a low electric potential voltage is applied to the gate electrodes of each area and the TFTs 103 are held in an on state and a period (b2) (second period) during which a high electric potential voltage is applied to the gate electrodes of each area and the TFTs 103 are held in an off state. During the period (b1), the pixel electrodes 104 and the holding capacitors Cs are charged, and during the period (b2), movement of the electrophoretic particles will be completed.

Next, FIG. 3C shows that the black character “B” is displayed on the white background on the display portion. Here, the area of the character “B” is denoted as area c. At the time of writing “B”, as shown in a period (c) in FIG. 4, the common electrode Com is applied with a low electric potential voltage. In addition, the pixel electrodes 104 corresponding to the area c are applied with a high electric potential voltage, and the pixel electrodes 104 corresponding to the area other than the area c are applied with a low electric potential voltage. By so doing, as shown in FIG. 5C, black electrophoretic particles that are positively charged move toward the common electrode Com only in the area c. Thus, the character “B” is displayed.

Then, as shown in FIG. 4, the period (c) also includes a period (c1) (first period) during which a low electric potential voltage is applied to the gate electrodes of each area and the TFTs 103 are held in an on state and a period (c2) (second period) during which a high electric potential voltage is applied to the gate electrodes of each area and the TFTs 103 are held in an off state. During the period (c1), the pixel electrodes 104 and the holding capacitors Cs are charged, and during the period (c2), movement of the electrophoretic particles will be completed. Strictly speaking, the area b shown in FIG. 3A and the area b shown in FIG. 3C respectively include different areas; however, for easier description, a description is made using the same reference sign assigned to these areas in the context that these are background areas, other than the character area, to which the same electric potential is applied.

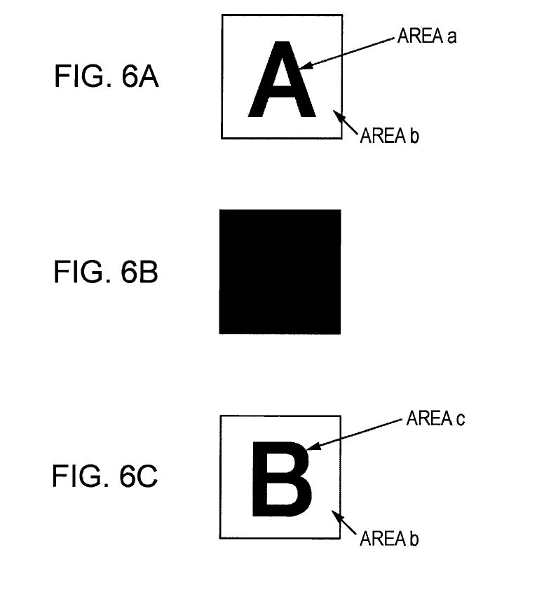

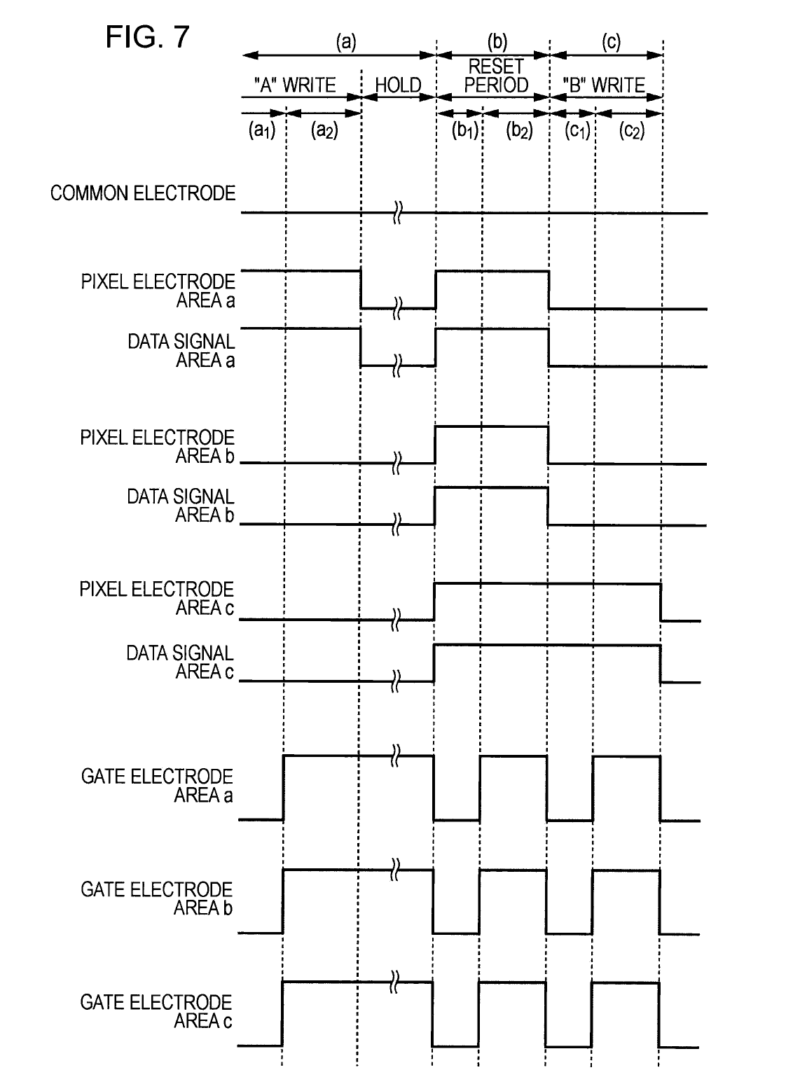

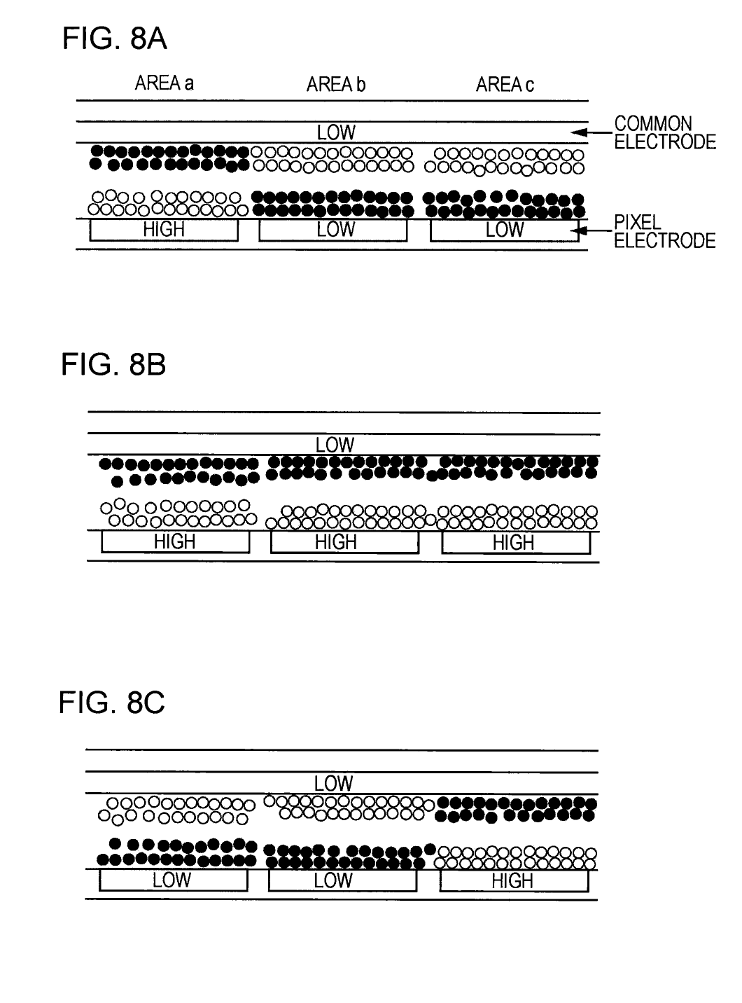

In addition, the entire display portion performs white display during the reset period in the example shown in FIG. 3A to FIG. 5C; however, as shown in FIG. 6A to FIG. 8C, a method to make the entire display portion perform black display during the reset period may be employed. As shown in the drawing, only the operation during the reset period (b) is different from that of the example shown in FIG. 3A to FIG. 5C. As shown in FIG. 6B, the entire display portion performs black display during the reset period. As shown in FIG. 7, during the reset period, the common electrode Com is applied with a low electric potential voltage, and all the pixel electrodes 104 are applied with a high electric potential voltage. By so doing, as shown in FIG. 8B, white electrophoretic particles move toward the pixel electrodes 104 in the areas b and c, so that the entire display portion appears to be black.

In addition, as shown in FIG. 7, a period (b) includes a period (b1) (first period) during which a low electric potential voltage is applied to the gate electrodes of each area and the TFTs 103 are held in an on state and a period (b2) (second period) during which a high electric potential voltage is applied to the gate electrodes of each area and the TFTs 103 are held in an off state. During the period (b1), the pixel electrodes 104 and the holding capacitors Cs are charged, and during the period (b2), movement of the electrophoretic particles will be completed. Strictly speaking, the area b shown in FIG. 6A and the area b shown in FIG. 6C respectively include different areas; however, for easier description, a description is made using the same reference sign assigned to these areas in the context that these are background areas, other than the character area, to which the same electric potential is applied.

As described above, if the gate electrode of a P-type transistor is applied with a negative bias voltage, degradation of characteristic due to carrier trap occurs. According to the present embodiment, each of the reset period and the image writing period provides a first period during which the TFTs 103 are held in an on state and a second period during which the TFTs 103 are held in an off state, and, during the first period, the pixel electrodes 104 are charged and, during the second period, electrophoretic particles are caused to move on the basis of differences in electric potential that are set through the charging. Thus, a negative bias voltage, which causes degradation of characteristic of the TFTs 103, is applied only during the first period, so that degradation of characteristic of the transistors due to carrier trap is suppressed and, hence, the display quality of the electrophoretic display device may be maintained.

Note that in the present embodiment, the TFTs 103 are P-type organic transistors; however, the TFTs 103 may be N-type organic transistors. In this case, to make the TFT 103 enter an on state, the gate electrode is applied with a positive voltage; however, if the N-type transistor is applied with a positive bias voltage, degradation of characteristic due to carrier trap occurs. Thus, as in the case of the present embodiment, each of the reset period and the image writing period provides a first period during which the TFTs 103 are held in an on state and a second period during which the TFTs 103 are held in an off state, and, during the first period, the pixel electrodes 104 are charged and, during the second period, electrophoretic particles are caused to move on the basis of differences in electric potential that are set through the charging. Thus, a positive bias voltage, which causes degradation of characteristic of the TFTs 103, is applied only during the first period, so that degradation of characteristic of the transistors due to carrier trap is suppressed and, hence, the display quality of the electrophoretic display device may be maintained.

In addition, in the present embodiment, the electrophoretic particles include white electrophoretic particles that are negatively charged and black electrophoretic particles that are positively charged; however, the configuration of the electrophoretic particles are not limited to it. For example, when the electrophoretic particles include white electrophoretic particles that are positively charged and black electrophoretic particles that are negatively charged, or when color particles other than black or white are employed, the same advantageous effects may also be obtained.

### Second Embodiment

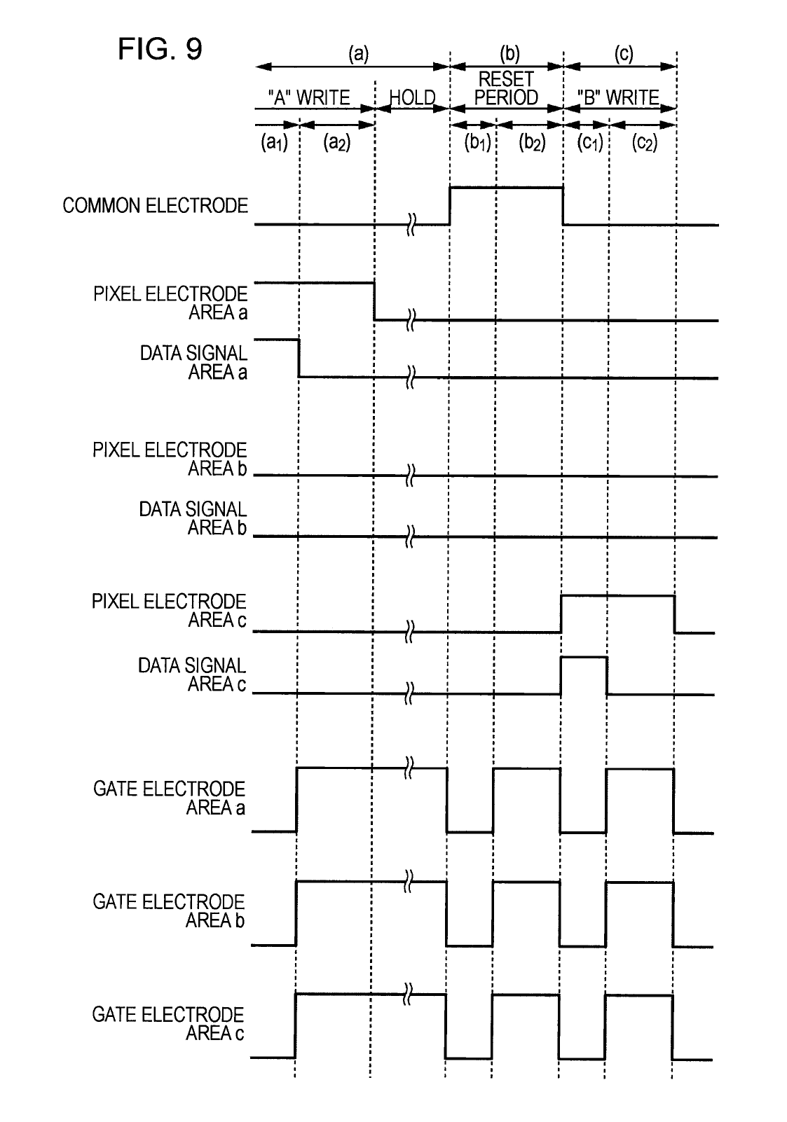

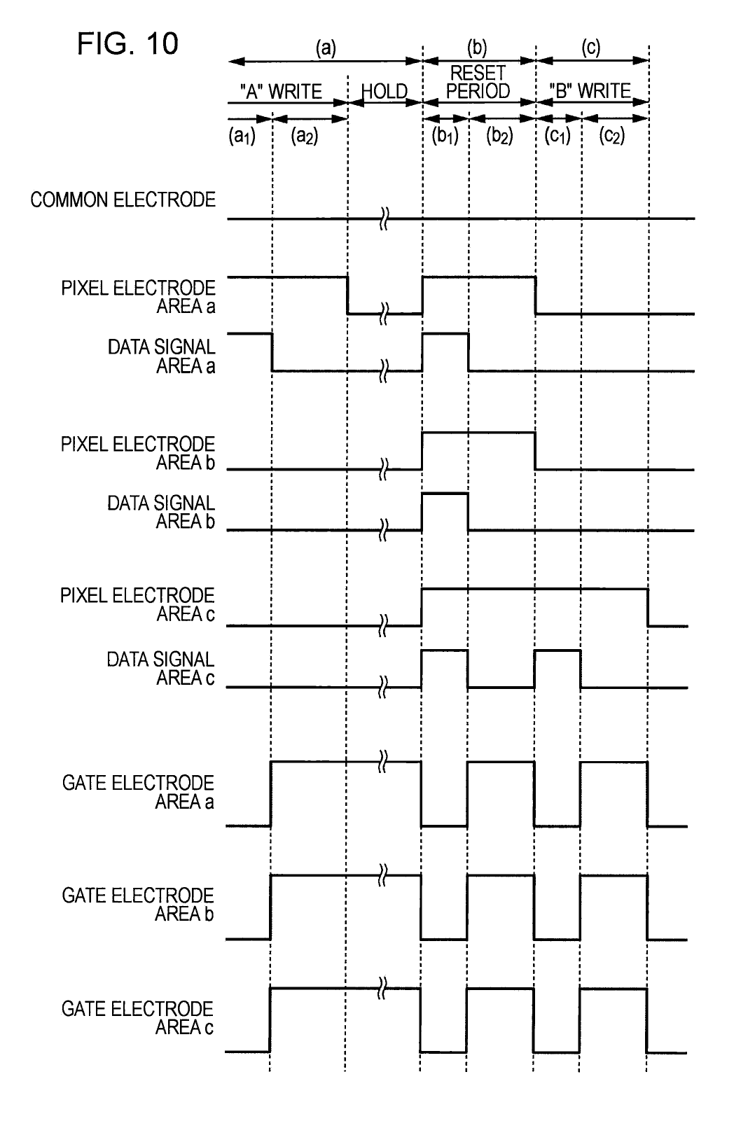

FIG. 9 and FIG. 10 are timing charts, each of which shows voltages of a common electrode, pixel electrode, data signal, and gate electrode of the electrophoretic display device according to a second embodiment. FIG. 9 shows a case in which the entire display portion performs white display during a reset period. FIG. 10 shows a case in white the entire display portion performs black display during a reset period. The configuration of the electrophoretic display device is the same as that of the first embodiment shown in FIG. 1 and FIG. 2.

In the second embodiment, each of the reset period and the image writing period provides a first period during which the TFTs 103 are held in an on state to charge the pixel electrodes 104 and a second period during which the TFTs 103 are held in an off state to cause the electrophoretic particles to move, as in the case of the first embodiment. Furthermore, in the second embodiment, during the second period, a low electric potential signal is supplied from the data lines 102 to the TFTs 103.

A description will now be made with reference to FIG. 9. During the period (a2) (second period), the data lines 102 corresponding to the respective image areas a, b, c each output a low electric potential signal. Particularly, in the area a, the data signals change from a high electric potential to a low electric potential when shifting from the period (a1) (first period) to the period (a2). This differs from that of the first embodiment.

To appropriately cause the electrophoretic particles to move to perform image writing, it is only necessary to hold differences in electric potential between the common electrode Com and the pixel electrodes 104 in each of the areas. During the period (a2), the TFTs 103 are held in an off state and, as a result, no data signals are supplied to the pixel electrodes 104. Thus, as shown in FIG. 9, even when the data signals are changed to a low electric potential during the period (a2), the state of charge of the pixel electrodes 104 remains unchanged and, as a result, differences in electric potential between the pixel electrodes 104 and the common electrode Com are held.

On the other hand, by setting the data signals to a low electric potential, the gate electrodes of the TFTs 103 are applied with a positive bias voltage. Thus, it is possible to recover degradation of characteristic due to a negative bias voltage applied during the period (a1).

As shown in FIG. 9, during the second period (b2) in the reset period (b) and during the second period (c2) in the writing period (c) as well, the data signals are set to a low electric potential in all the pixels. In addition, in FIG. 10 as well, during the second periods (a2), (b2), (c2), the TFTs 103 are held in an off state, and the data signals are set to a low electric potential.

As described above, according to the second embodiment, during each of the reset period and the image writing period, not only the second period during which the TFTs 103 are held in an off state to wait for completion of movement of the electrophoretic particles is provided but also, during the second period, the data signals are set to a low electric potential in all the pixels, so that it is possible to recover degradation of characteristic due to a negative bias voltage applied during the first period.

In addition, the second embodiment, as well as the first embodiment, may be applied even when the TFTs 103 are N-type transistors. In this case, during the second period, when the data signals are set to a high electric potential in all the pixels, the gate electrodes of the TFTs 103 are applied with a negative bias voltage, it is possible to recover degradation of characteristic due to a positive bias voltage applied during the first period.

### Electronic Apparatuses

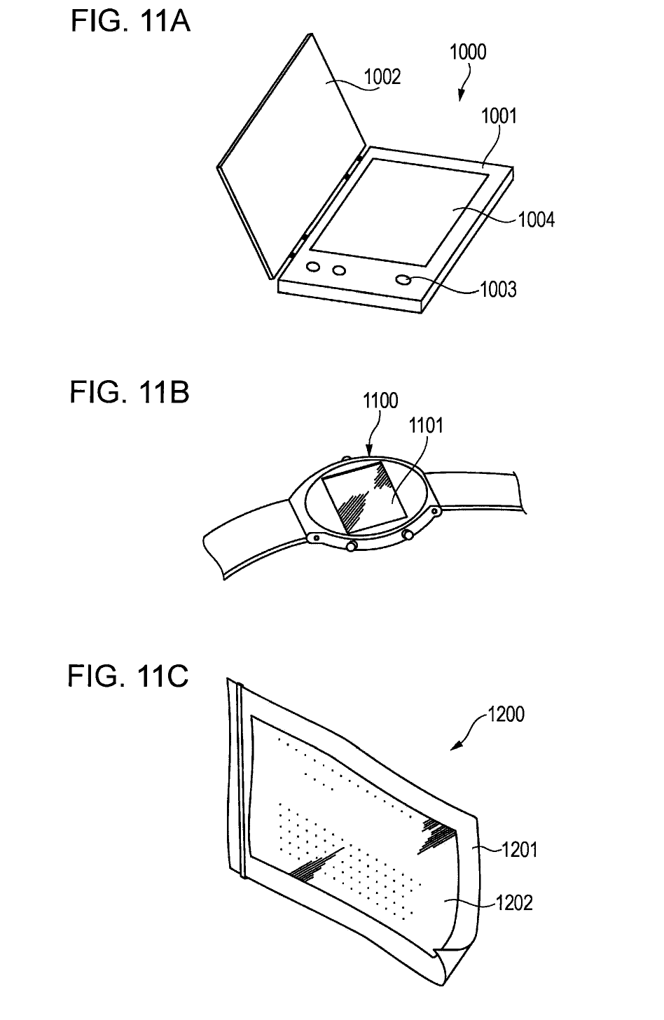

FIG. 11A to FIG. 11C are perspective views that illustrate specific examples of an electronic apparatus that employs the electrophoretic display device according to the aspects of the invention. FIG. 11A is a perspective view that shows an electronic book, which is an example of an electronic apparatus. The electronic book 1000 includes a book-shaped frame 1001, an (openable) cover 1002 provided pivotally to the frame 1001, an operating portion 1003, and a display portion 1004 constituted of the electrophoretic display device according to the aspects of the invention.

FIG. 11B is a perspective view that shows a watch, which is an example of an electronic apparatus. The watch 1100 includes a display portion 1101 constituted of the electrophoretic display device according to the aspects of the invention.

FIG. 11C is a perspective view that shows an electronic paper, which is an example of an electronic apparatus. The electronic paper 1200 includes a main body portion 1201 constituted of a flexible rewritable sheet having a similar texture to paper and a display portion 1202 constituted of the electrophoretic display device according to the aspects of the invention.

For example, an electronic book and an electronic paper are presumably used to repeatedly write characters on the white background thereof, so that it is necessary to remove a residual image at the time of erasing or a residual image over time. Note that the electronic apparatus to which the electrophoretic display device according to the aspects of the invention is applicable is not limited to the above, but it widely includes apparatuses that use changes in ocular hue in accordance with movement of electrically charged particles.

The entire disclosure of Japanese Patent Application No. 2007-268266, filed Oct. 15, 2007 is expressly incorporated by reference herein.

What is claimed is:

1. An electrophoretic display device comprising:
a common electrode and a plurality of pixel electrodes;
a disperse system containing electrophoretic particles, the disperse system being held between the common electrode and the plurality of pixel electrodes;
a display portion formed of a plurality of pixels;
a switching transistor, which supplies a corresponding one of the pixel electrodes with a low electric potential signal or a high electric potential signal supplied from a signal line; and
a control portion that controls an electric potential applied between each of the pixel electrodes and the common electrode to cause the electrophoretic particles to move, wherein
the control portion provides, in a period during which control for causing the electrophoretic particles to move is performed, a first period during which the switching transistor is held in an on state and a second period during which the switching transistor is held in an off state, and wherein
the first period continues until charging of the pixel electrode is complete, and the second period continues from an end of the first period until movement of the electrophoretic particles is complete.

2. The electrophoretic display device according to claim 1, wherein
the switching transistor enters an on state when a gate electrode of the switching transistor is supplied with a first electric potential and enters an off state when the gate electrode is supplied with a second electric potential, and wherein
during the second period,
the control portion supplies the low electric potential signal from the signal line to the switching transistor when the first electric potential is smaller than the second electric potential, and
the control portion supplies the high electric potential signal from the signal line to the switching transistor when the first electric potential is larger than the second electric potential.

3. The electrophoretic display device according to claim 1, wherein
the control portion provides a reset period during which differences in electric potential between the common electrode and the pixel electrodes in all the pixels are set to be equal during times when an image displayed on the display portion is rewritten from a first image to a second image to thereby make the entire display portion appear to be the same gray-scale level, and wherein
the reset period includes the first period and the second period.

4. The electrophoretic display device according to claim 3, wherein the switching transistor is an organic thin film transistor.

5. The electrophoretic display device according to claim 1, wherein
when the switching transistor is a P-channel transistor, the control portion supplies the low electric potential signal from the signal line to the switching transistor during the second period.

6. The electrophoretic display device according to claim 1, wherein
when the switching transistor is an N-channel transistor, the control portion supplies the high electric potential signal from the signal line to the switching transistor during the second period.

7. An electronic apparatus comprising the electrophoretic display device according to claim 1.

8. A method of driving an electrophoretic display device that includes a common electrode and a plurality of pixel electrodes, a disperse system containing electrophoretic particles, the disperse system being held between the common electrode and the plurality of pixel electrodes, and a switching transistor, which supplies a corresponding one of the pixel electrodes with a low electric potential signal or a high electric potential signal supplied from a signal line, wherein an electric potential applied between each of the pixel electrodes and the common electrode is controlled to cause the electrophoretic particles to move, the method comprising:
when the electrophoretic particles are caused to move,
holding the switching transistor in an on state; and
holding the switching transistor in an off state, wherein holding the switching transistor in an on state continues until charging of the pixel electrode is complete, and wherein
holding the switching transistor in an off state continues from an end of holding the switching transistor in an on state until movement of the electrophoretic particles is complete.

9. The method of driving the electrophoretic display device according to claim 8, wherein
the switching transistor enters an on state when a gate electrode of the switching transistor is supplied with a first electric potential and enters an off state when the gate electrode is supplied with a second electric potential, wherein
during times when holding the switching transistor in an off state,
the low electric potential signal is supplied from the signal line to the switching transistor when the first electric potential is smaller than the second electric potential, and
the high electric potential signal is supplied from the signal line to the switching transistor when the first electric potential is larger than the second electric potential.
